(19) United States
(12) Patent Application Publication
(10) Pub. No.: US 2026/0331336 A1
(43) Pub. Date: Oct. 22, 2026

(54) MECHANIZED INTELLIGENT EQUIPMENT FOR SUBSTATION SECONDARY WIRING, AND CORE PREPROCESSING TOOL MAGAZINE AND METHOD THEREOF

(71) Applicants: State Grid Henan Economic Research Institute, Zhengzhou (CN); Chongqing University, Chongqing (CN)

(72) Inventors: Xiaofan SONG, Zhengzhou (CN); Fei GUO, Zhengzhou (CN); Liang ZHANG, Zhengzhou (CN); Song WANG, Zhengzhou (CN); Chen CHEN, Zhengzhou (CN); Jiepeng LIU, Chongqing (CN); Qi LI, Chongqing (CN); Wenjie XUE, Zhengzhou (CN); Jinfeng ZHANG, Zhengzhou (CN); Huanruo QI, Zhengzhou (CN); Qimin LI, Chongqing (CN); Shuai LI, Chongqing (CN); Jingbo SONG, Zhengzhou (CN); Han YAO, Zhengzhou (CN); Fang GUO, Zhengzhou (CN); Weihao XU, Zhengzhou (CN); Shunran WANG, Zhengzhou (CN); Weizhen ZHANG, Zhengzhou (CN)

(73) Assignees: State Grid Henan Economic Research Institute, Zhengzhou (CN); Chongqing University, Chongqing (CN)

(21) Appl. No.: 19/653,100

(22) Filed: Apr. 20, 2026

(30) Foreign Application Priority Data
Apr. 22, 2025 (CN) 2025105079272

(51) Int. Cl. H01B 15/00

(52) U.S. Cl. CPC H01B 15/00

(57) ABSTRACT

Disclosed is a core preprocessing tool magazine, wherein by disposing a core cutting unit, a core is conveyed by a first core conveying mechanism, and a lower blade and an upper blade are driven by a first power device to move relative to each other to implement a core cutting operation; by disposing a peeling processing unit, the cut core is conveyed by a second core conveying mechanism, and a peeling mechanism is driven by a second power device to complete a peeling operation on the core; by disposing a cable marker sleeving unit, the peeled core and a cable marker are conveyed by a third core conveying mechanism and a cable marker conveying mechanism respectively, and after a front end of the cable marker is sleeved on the core, the cable marker is cut off by a cable marker cutting mechanism.

### CROSS-REFERENCE TO RELATED APPLICATIONS

The application claims priority to Chinese patent application No. 202510507927.2, filed on Apr. 22, 2025, the entire contents of which are incorporated herein by reference.

### TECHNICAL FIELD

The present disclosure belongs to the technical field of robots, specifically mechanized intelligent equipment for substation secondary wiring, and a core preprocessing tool magazine and method thereof.

### BACKGROUND

The construction quality and efficiency of substations have always been important indicators of power grid construction. Currently, as China's power grid construction moves towards mechanization and intelligence, the addition of mechanized equipment in substation construction is an inevitable trend in future power grid construction. This also places higher demands on the intelligence of equipment, which is in line with the State Grid's concept of “making full use of mechanized construction”.

Secondary wiring work in substation engineering refers to wiring operations for cables used to connect protection, measurement, control and signaling devices in substations. In a traditional mode, construction for secondary wiring scenarios involves manually inserting peeled cable cores into terminal blocks according to the engineering drawings. Various devices are then directly connected using copper or aluminum wires to form a fixed electrical circuit. This process includes steps such as cable head fabrication, cable tag marking and fixing, core arrangement and steps, and shielding installation. However, this wiring method requires a large amount of manpower, the construction process is not refined enough and wiring errors are prone to occur, and there is a lack of effective mechanized construction methods, which cannot meet requirements of power grid construction in the new era.

In addition, due to the lack of integrated preprocessing equipment in the secondary wiring field, existing secondary wiring solutions have the following shortcomings:

### (1) A Problem of Lack of Integrated Preprocessing Equipment

The current secondary wiring field lacks integrated preprocessing equipment, and functions of various solutions are fragmented, only able to achieve single-process functions such as cutting and peeling. This necessitates the use of multiple devices in practice and relies on manual coordination, resulting in a scattered equipment layout and high operating costs.

### (2) A Problem of Inconsistent Core Processing Caused by Reliance on Manual Labor Throughout the Entire Process

The entire process relies heavily on manual labor, requiring operators to complete more than 10 action steps. This results in poor consistency in the geometric parameters of the cores, significant deviations in process standards, and difficulty in achieving uniformity and standardization in core processing, ultimately affecting the stability of product quality.

### (3) A Problem of Increased Core Time Consumption and Loss Due to Physical Isolation of Multiple Processes

During a complete core preprocessing process, due to the multi-process physical isolation architecture, the core needs to undergo multiple manual transfers. This not only increases the processing time of the single core, but also leads to increased core loss, reducing production efficiency and material utilization.

### (4) A Problem of Poor Control Accuracy of a Core Cutting Length

The core cutting process relies on manual visual positioning, resulting in poor length control accuracy and easy occurrence of length errors. This poses a structural risk to gaps at wiring ends, affecting the reliability and stability of subsequent wiring work.

(5) A Problem that the Core Peeling Process is Limited by Manual Operations

The core peeling process is limited by manual operations, and a cutting depth of the insulation layer fluctuates greatly, resulting in an excessively high conductor shielding residue rate. Meanwhile, the manual operations can easily damage the conductive material in the core, affecting conductivity and reducing product quality.

### (6) Problems in Cable Marker Position Identification and Automatic Sleeving Equipment

The existing equipment has low accuracy in identifying the position of the cable marker, requiring secondary manual verification. The lack of low-cost and highly efficient integrated automatic core sleeve equipment on the market has affected improvement of production efficiency and automation level.

### (7) A Problem of Poor Flexibility in Adjusting a Bending Angle of the Core

Existing core bending equipment uses a fixed limit module for bending angle adjustment, which cannot flexibly achieve free change of the bending angle. In addition, multiple limit components are required to achieve bending, and control between components is complicated, which reduces production efficiency and flexibility.

### (8) A Problem of Missing Closed-Loop Feedback in Core Conveying Devices

The existing core processing equipment lacks closed-loop feedback in the core conveying devices, making it impossible to adaptively adjust to the core size and provide real-time feedback on the core status. This makes it difficult to accurately control the core conveying length, affecting production quality and efficiency.

### (9) Problems of a Complex Equipment Structure and High Maintenance Costs

Existing core processing equipment has a complex structure and numerous internal components, which leads to high maintenance costs, increases the operational burden on enterprises, and reduces the reliability and availability of the equipment.

### SUMMARY

In view of this, the purpose of the present disclosure is to provide mechanized intelligent equipment for substation secondary wiring, and a core preprocessing tool magazine and method thereof. The present disclosure integrates various functions such as core cutting, peeling, conveying, cable marker sleeving, and bending, and eliminates a traditional multi-device integration and manual connection method, thereby achieving full-process automation of core preprocessing, greatly improving production efficiency and reducing operating costs.

To achieve the above purposes, the present disclosure provides the following technical solution.

The present disclosure first proposes a core preprocessing tool magazine, including a core cutting unit, a peeling processing unit, a cable marker sleeving unit, and a bending unit;
the core cutting unit includes a first core conveying mechanism and a core cutting mechanism; the first core conveying mechanism is used to drive a core to be cut to move toward the core cutting mechanism and to drive the cut core to exit; the core cutting mechanism includes a lower blade and an upper blade disposed opposite to each other, and a first power device used to drive the lower blade and the upper blade to move relative to each other to cut off the core;
the peeling processing unit includes a second core conveying mechanism and a peeling mechanism; the second core conveying mechanism is used to drive the core to be peeled to move toward the peeling mechanism and to drive the peeled core to exit; the peeling mechanism includes a peeling cutter and a second power device used to drive the peeling cutter to rotate about an axis thereof;
the cable marker sleeving unit includes a third core conveying mechanism, a cable marker conveying mechanism, and a cable marker cutting mechanism; the third core conveying mechanism and the cable marker conveying mechanism are disposed opposite to each other and at a same height; the cable marker cutting mechanism is located between the third core conveying mechanism and the cable marker conveying mechanism and is provided with a positioning support used to position the core and a cable marker; the third core conveying mechanism is used to drive the core to be sleeved to move toward the cable marker cutting mechanism and the sleeved core to exit; the cable marker conveying mechanism is used to drive the cable marker to move toward the cable marker cutting mechanism so as to sleeve the cable marker onto the corresponding core; and the cable marker cutting mechanism is used to cut off the cable marker so as to make an end of the cable marker remain on the core; and
the bending unit includes a fourth core conveying mechanism and a bending mechanism; the fourth core conveying mechanism is used to convey the core to the bending mechanism in twice at a set length; the bending mechanism includes a bending turntable and a fourth power device; the bending turntable is used to bend the core in both forward and reverse directions; and the fourth power device is used to drive the bending turntable to rotate in opposite directions respectively after the core is conveyed to the bending turntable in twice.

Further, the first core conveying mechanism, the second core conveying mechanism, the third core conveying mechanism, and the fourth core conveying mechanism are core conveying mechanisms adopting a same structure; the core conveying mechanism includes a core conveying mounting frame, a first core conveying roller and a second core conveying roller disposed opposite to each other and a core conveying power device in transmission connection with a rotating shaft of the first core conveying roller are mounted on the core conveying mounting frame; the rotating shafts of the first core conveying roller and the second core conveying roller are provided with mutually meshing gears respectively.

Further, the core conveying power device includes a power motor mounted on the core conveying mounting frame, and an output shaft of the power motor is in transmission connection with the rotating shaft of the first core conveying roller by a synchronous belt mechanism.

Further, the core conveying mechanism further includes a spacing adjustment mechanism used to adjust a position of the second core conveying roller; the spacing adjustment mechanism includes an adjustment track disposed on the core conveying mounting frame and a gap adjustment slider in sliding fit with the adjustment track, and the rotating shaft of the second core conveying roller is in rotating fit with the gap adjustment slider; a position adjustment mechanism is disposed between the gap adjustment slider and the core conveying mounting frame; the position adjustment mechanism is used to adjust a position of the gap adjustment slider on the adjustment track to adjust a spacing between the second core conveying roller and the first core conveying roller.

Further, the peeling cutter is provided with a through hole for inserting the core inside, and a cutter head mounting hole is provided on a side wall of the through hole; and a peeling cutter head used to peel the core is mounted in the cutter head mounting hole.

Further, the cable marker sleeving unit includes a sleeve mounting frame, the cable marker conveying mechanism includes two sleeve conveying rollers disposed opposite to each other; the two sleeve conveying rollers are rotatably fit and mounted on the sleeve mounting frame; the sleeve mounting frame is provided with a sleeve conveying power device in transmission connection with the rotating shaft of one of the sleeve conveying rollers, and the two sleeve conveying rollers are in transmission connection by a synchronous belt mechanism.

Further, the cable marker cutting mechanism includes a positioning support, a first blade and a second blade are disposed opposite to each other on the positioning support, and the second blade is located below the first blade; the second blade is fixedly mounted on the positioning support, a vertical track is disposed in the positioning support, the first blade is slidably fit and mounted in the vertical track, and the positioning support is provided with a reset spring used to drive the first blade to move upward and a third power device used to drive the first blade to move downward to cut off the cable marker; and when the first blade is reset by the action of the reset spring, a positioning through hole used to position the core and the cable marker is formed between the first blade and the second blade.

Further, the bending turntable includes a base turntable, a core guide plate which is in rotating fit with the base turntable and is fixed is mounted on the base turntable, two guide pillars disposed opposite to each other are mounted on the core guide plate, and a guide channel used for the core to pass through is formed between the two guide pillars; the base turntable is provided with a bending pillar used to drive bending of the core; and the fourth power device is in transmission connection with the base turntable.

The present disclosure further proposes a core preprocessing method using the core preprocessing tool magazine described above, including the following steps:
S1: core cutting
S11: gripping, by a robotic arm, the core and feeding the core into the first core conveying mechanism, after a photoelectric sensor detects that the core has been fed in place, starting the first core conveying mechanism to convey the core toward the core cutting mechanism, and after a feeding length of the core is measured in real time to reach a first preset length value, stopping the first core conveying mechanism;
S12: starting the first power device to drive the core cutting mechanism to cut off the core, and after a grayscale sensor detects that the core has been cut off, using the first power device to drive the core cutting mechanism to reset;
S13: starting the first core conveying mechanism to drive the cut core to exit from the core cutting unit, and after the photoelectric sensor detects that the core has completely exited, executing step S2;
S2: core peeling
S21: griping, by the robotic arm, the core and feeding the core into the second core conveying mechanism, after the photoelectric sensor detects that the core has been fed in place, starting the second core conveying mechanism to convey the core toward the peeling mechanism, and after the feeding length of the core is measured in real time to reach a second preset length value, inserting an core end into the peeling cutter, and stopping the second core conveying mechanism;
S22: starting the second power device to drive the peeling cutter to rotate around an axis thereof to peel the core end, and after the grayscale sensor detects that the core end has been peeled, stopping the second power device;
S23: starting the second core conveying mechanism to drive the peeled core to exit from the peeling processing unit, and after the photoelectric sensor detects that the core has completely exited, executing step S3;
S3: cable marker sleeving of the core
S31: griping, by the robotic arm, the core and feeding the core into the third core conveying mechanism, after the photoelectric sensor detects that the core has been fed in place, starting the third core conveying mechanism to convey the core toward the cable marker cutting mechanism, and after the feeding length of the core is measured in real time to reach a third preset length value, stopping the third core conveying mechanism;
starting the cable marker conveying mechanism to convey the cable marker toward the cable marker cutting mechanism, and after the cable marker is made to pass through the cable marker cutting mechanism and reach a set position, sleeving a front end of the cable marker onto the core, and stopping the cable marker conveying mechanism;
S32: starting the cable marker cutting mechanism to cut off the cable marker, and after the grayscale sensor detects that the core is sleeved with the cable marker, resetting the cable marker cutting mechanism;
S33: starting the third core conveying mechanism to drive the sleeved core to exit from the cable marker sleeving unit, and after the photoelectric sensor detects that the core has completely exited, executing step S4;
S4: core bending
S41: gripping, by the robotic arm, the core and feeding the core into the fourth core conveying mechanism, after the photoelectric sensor detects that the core has been fed in place, starting the fourth core conveying mechanism to convey the core toward the bending mechanism, and after the feeding length of the core is measured in real time to reach a fourth preset length value, stopping the fourth core conveying mechanism;
S42: starting the fourth power device to drive the bending turntable to rotate forward to the set position, and bending the core forward;
S43: starting the fourth core conveying mechanism to convey the core toward the bending mechanism, and after the feeding length of the core is measured in real time to reach a fifth preset length value, stopping the fourth core conveying mechanism;
S44: starting the fourth power device to drive the bending turntable to rotate reversely to the set position, and bending the core reversely;
S45: gripping, by the robotic arm, the bent core, and using vision to detect an S-bend shape of the core.

The present disclosure further proposes mechanized intelligent equipment for substation secondary wiring, including:
a rack, provided with a lifting mechanism;
a wiring work platform, mounted on the lifting mechanism and used to perform secondary wiring operations;
a lifting module, used to control the lifting mechanism to drive the wiring work platform to perform lifting movements so as to meet wiring operation requirements of terminal blocks at different heights within a single panel cabinet;
a tool magazine module, mounted on the wiring work platform and used to perform core preprocessing operations before secondary wiring;
a host computer module, used to deploy control programs required for the secondary wiring operations;
a slave computer module, disposed in one-to-one correspondence with the wiring work platform, the lifting module and the tool magazine module, and used to control the corresponding wiring work platform, the lifting module or the tool magazine module to perform corresponding actions according to the control programs;
the tool magazine module adopts the core preprocessing tool magazine as described in any one of claims 1-8;
the wiring work platform is provided with two robotic arms, and the ends of the two robotic arms are interchangeably provided with a main wiring execution module and a slave wiring execution module, wherein: the robotic arm provided with the main wiring execution module is a main robotic arm, and the robotic arm provided with the slave wiring execution module is a slave robotic arm;
the main wiring execution module includes an electric gripper, a first vision module, and a force sensing module, wherein the electric gripper is used to grip the core, the first vision module is used to identify a position and a posture of the core, and the force sensing module is used to sense whether core wiring is in place and secure; the slave wiring execution module includes a tightening module and a second vision module, wherein the tightening module is used to tighten screws on the side of the terminal block, and the second vision module is used to identify a position of a terminal block socket.

The beneficial effects of the present disclosure are as follows:

According to the core preprocessing tool magazine of the present disclosure, by disposing the core cutting unit, the core is conveyed by the first core conveying mechanism, and the lower blade and the upper blade are driven by the first power device to move relative to each other to implement a core cutting operation; by disposing the peeling processing unit, the cut core is conveyed by the second core conveying mechanism, and the peeling mechanism is driven by the second power device to complete a peeling operation on the core; by disposing the cable marker sleeving unit, the peeled core and the cable marker are conveyed by the third core conveying mechanism and the cable marker conveying mechanism respectively, and after the front end of the cable marker is sleeved on the core, the cable marker is cut off by the cable marker cutting mechanism, so that the cut cable marker remains at the front end of the core, thereby implementing the operation of sleeving the cable marker on the core; and by disposing the bending unit, the core is conveyed by the fourth core conveying mechanism to the bending mechanism, and the bending mechanism is driven by the fourth power device to rotate forward and reversely to bend the core into a set shape. In this way, the core preprocessing tool magazine of the present disclosure integrates various functions such as core cutting, peeling, conveying, cable marker sleeving, and bending, and eliminates a traditional multi-device integration and manual connection method, thereby achieving full-process automation of core preprocessing, greatly improving production efficiency and reducing operating costs.

The core preprocessing tool magazine of the present disclosure has the following advantages:
(1) High degree of integration: the present disclosure integrates various functions such as core cutting, peeling, conveying, cable marker sleeving, and bending, and eliminates a traditional multi-device integration and manual connection method, thereby achieving full-process automation of core preprocessing, greatly improving production efficiency and reducing operating costs.
(2) Structural optimization and innovation: Each unit has a clever structural design. For example, the core cutting unit uses an up-down cooperation manner of a powerful push rod and blades. The peeling processing unit uses a combination of a motor-connected shaft neck, a connecting rod, and a chuck. The bending unit uses a base turntable that rotates relative to the core guide plate and uses a bending pillar to limit the core, thereby driving the core to bend into a set S-shaped bend. These innovative structures simplify traditional complex structures and reduce the size and weight of the equipment while achieving the functions.
(3) High precision and high adaptability: The conveying mechanism adjusts the roller spacing by rotating the gears to accommodate cores of different specifications, and uses a motor encoder to precisely control the conveying length; the cable marker sleeving unit ensures sleeve accuracy through roller height consistency and the positioning support; the bending unit can flexibly achieve S-shaped bending of the core and is easy to control. These features ensure the high precision and adaptability of the equipment in different core processing tasks, and improve the stability and consistency of product quality.
(4) Easy operations and maintenance: Because of the integration and optimized structure of the equipment, the operation process is greatly simplified, reducing manual intervention and cumbersome operating steps. At the same time, compared with traditional complex equipment, the maintenance of the present disclosure is more convenient, reducing maintenance costs and difficulties, improving the reliability and availability of the equipment, and reducing the operational burden on enterprises.

### BRIEF DESCRIPTION OF DRAWINGS

To make the purposes, technical solutions, and beneficial effects of the present disclosure clearer, the following drawings are provided for illustration:

FIG. 1 is a schematic structural diagram of an embodiment of a core preprocessing tool magazine of the present disclosure;

FIG. 2 is a schematic structural diagram of a core cutting mechanism;

FIG. 3 is a schematic structural diagram of a peeling mechanism;

FIG. 4 is a schematic structural diagram of a cable marker conveying mechanism;

FIG. 5 is a schematic structural diagram of a cable marker cutting mechanism;

FIG. 6 is a schematic structural diagram of a bending mechanism;

FIG. 7 is a schematic structural diagram of a conveying mechanism;

FIG. 8 is a schematic structural diagram of an embodiment of mechanized intelligent equipment for substation secondary wiring;

FIG. 9 is an upper axonometrical drawing of mechanized intelligent equipment for substation secondary wiring of this embodiment;

FIG. 10 is a lower axonometrical drawing of mechanized intelligent equipment for substation secondary wiring of this embodiment;

FIG. 11 is a system framework diagram of mechanized intelligent equipment for substation secondary wiring of this embodiment; and

FIG. 12 is a flowchart of a mechanized intelligent construction method for substation secondary wiring of the present disclosure.

### DESCRIPTION OF REFERENCE SIGNS

10—Rack; 11—Lifting track; 12—Lifting slider; 13—Motor transmission module; 14—Movable platform; 141—Base plate; 142—Roller; 20—Wiring work platform; 21—Main robotic arm; 22—Slave robotic arm; 23—Main wiring execution module; 231—Electric gripper; 232—First vision module; 233—Force sensing module; 24—Slave wiring execution module; 241—Tightening module; 242—Second vision module; 30—Lifting module; 31—Ultrasonic ranging module;
40—Tool magazine module; 41—Core conveying mounting frame; 42—First core conveying roller; 43—Second core conveying roller; 44—Gear; 45—Gear; 46—Power motor; 47—Synchronous belt mechanism; 481—Adjustment track; 482—Gap adjustment slider; 483—Screw;
50—Core cutting unit; 51—First core conveying mechanism; 52—Core cutting mechanism; 521—Lower blade; 522—Upper blade; 523—First power device; 524—Lower mounting base; 525—Upper mounting base;
60—Peeling processing unit; 61—Second core conveying mechanism; 62—Peeling mechanism; 621—Peeling cutter; 622—Through hole; 623—Cutter head mounting hole; 624—Second power device; 625—Chuck; 626—Motor connecting rod; 627—Cutter connecting rod;
70—Cable marker sleeving unit; 71—Third core conveying mechanism; 72—Cable marker conveying mechanism; 721—Sleeve conveying roller; 722—Sleeve conveying roller; 723—Sleeve conveying power device; 724—Drive pulley; 725—Driven pulley; 73—Cable marker cutting mechanism; 731—Positioning support; 732—First blade; 733—Second blade; 734—Third power device; 735—Positioning through hole; 736—Servo joystick; 737—Force-bearing rod; 74—Sleeve mounting frame;
80—Bending unit; 81—Fourth core conveying mechanism; 82—Bending mechanism; 821—Bending turntable; 822—Fourth power device; 823—Base turntable; 824—Core guide plate; 825—Guide pillar; 826—Guide channel; 827—Bending pillar.
90—Host computer module; 100—Slave computer module.

### DETAILED DESCRIPTION OF THE EMBODIMENTS

The present disclosure will be further described below with reference to the accompanying drawings and specific embodiments, so that those skilled in the art can better understand and implement the present disclosure. However, the embodiments described are not intended to limit the present disclosure.

### Embodiment 1

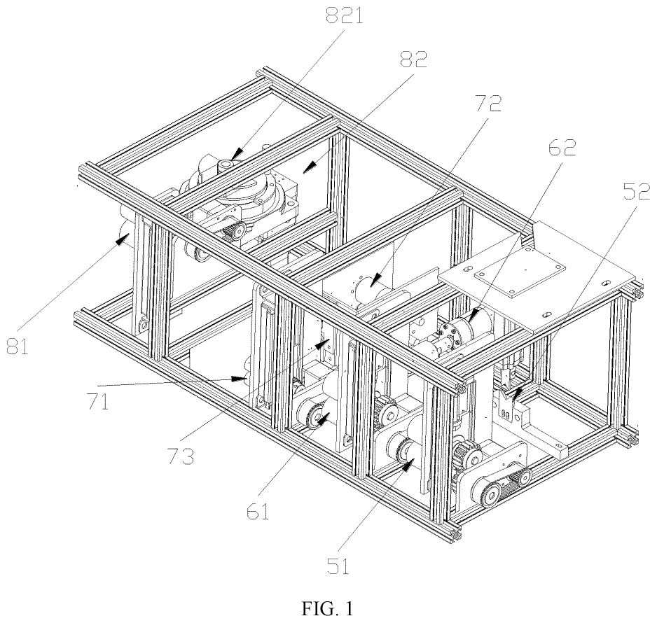

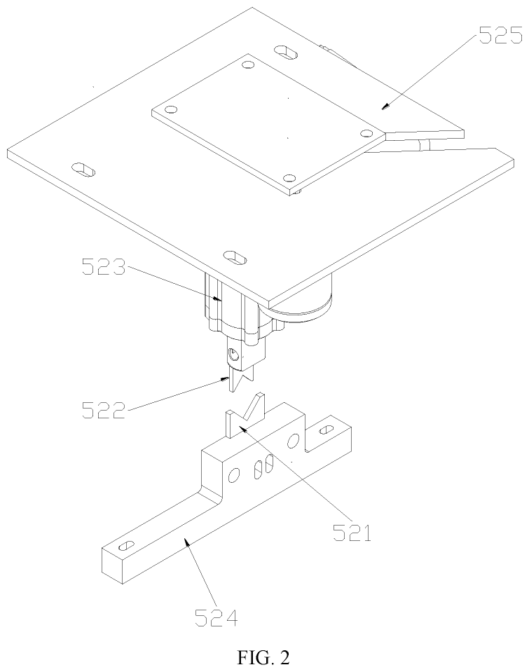

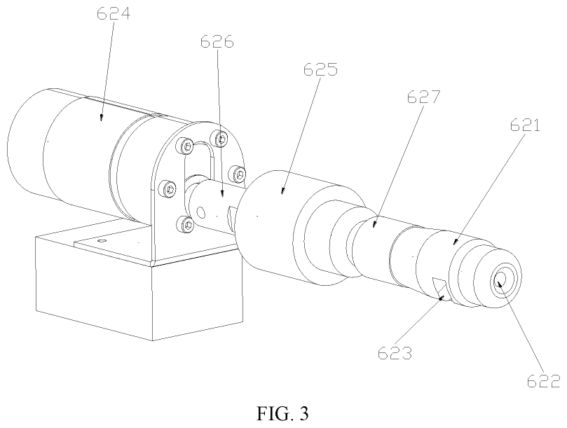

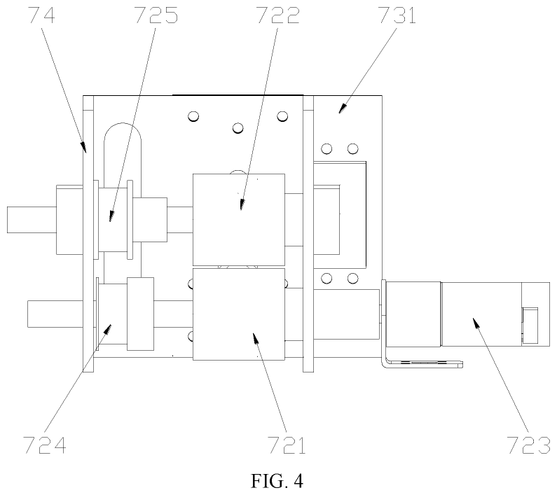

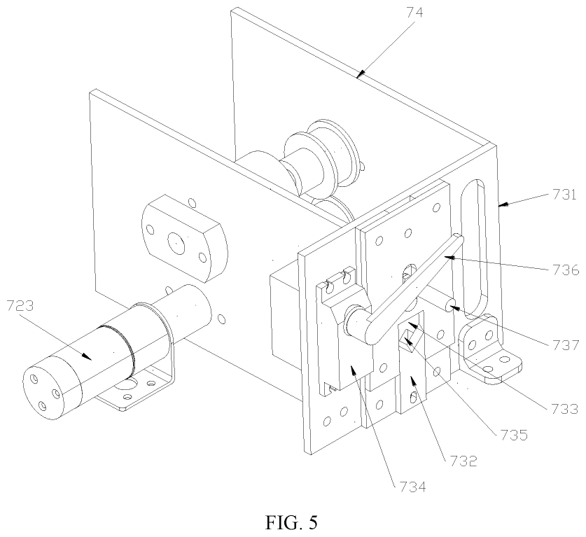

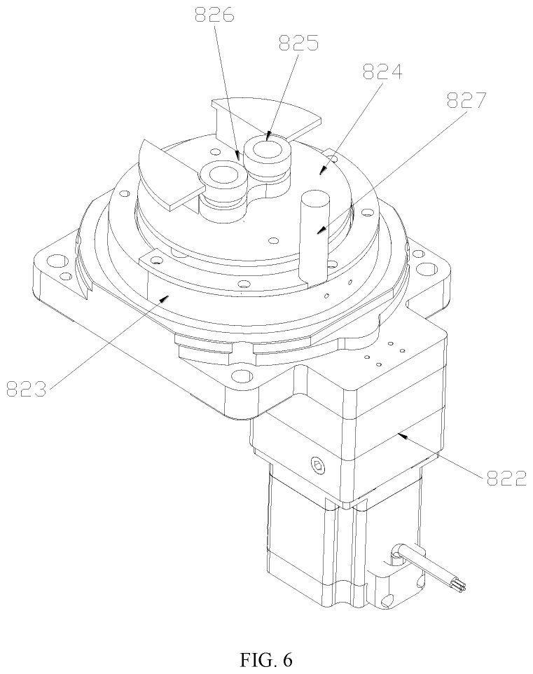

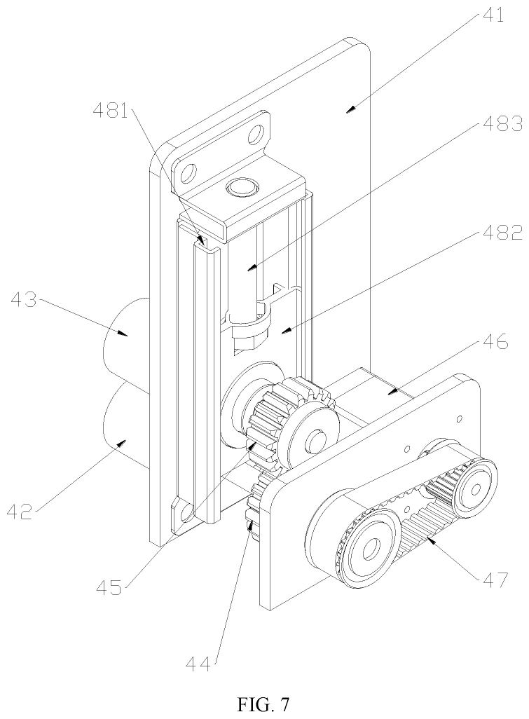

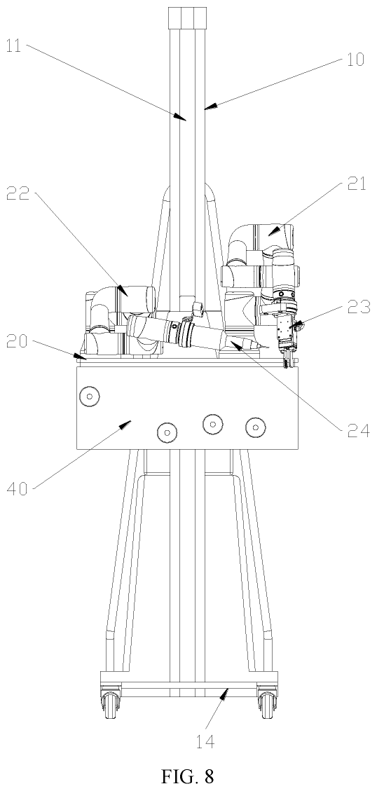

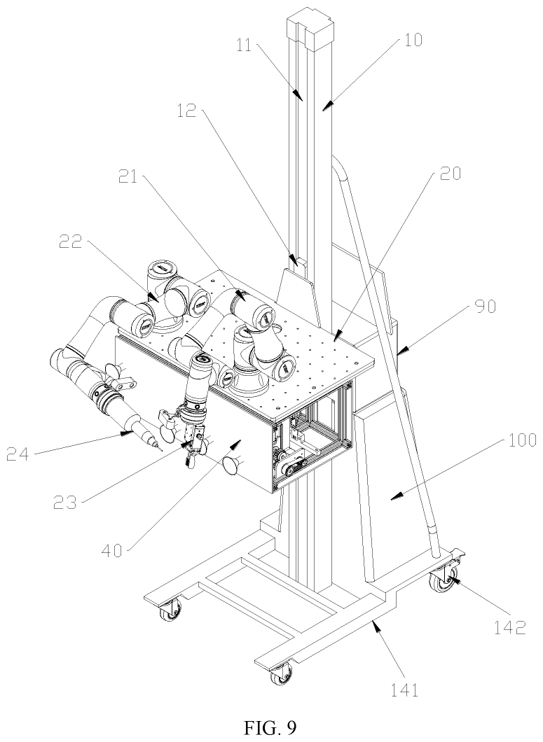

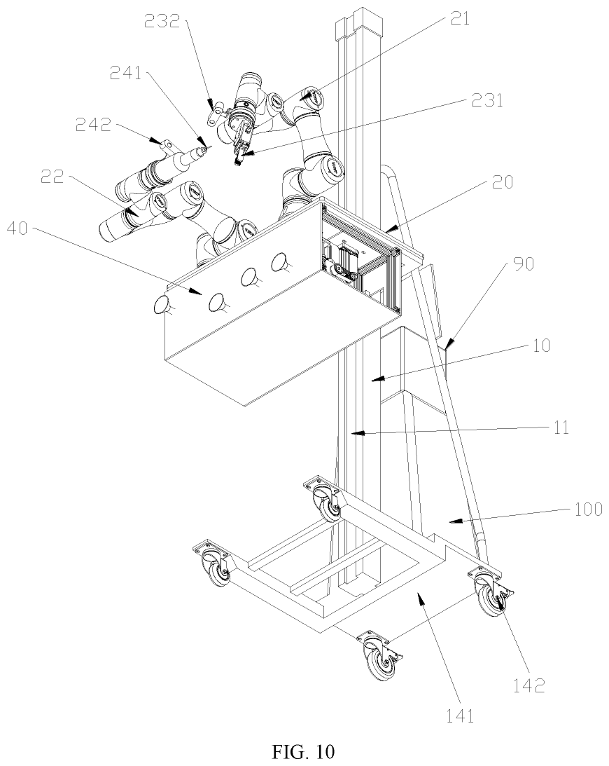

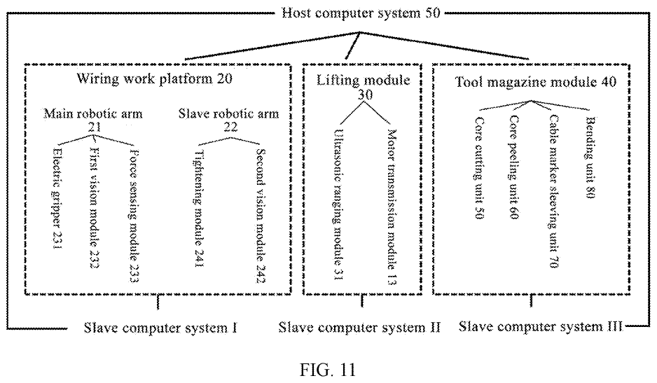

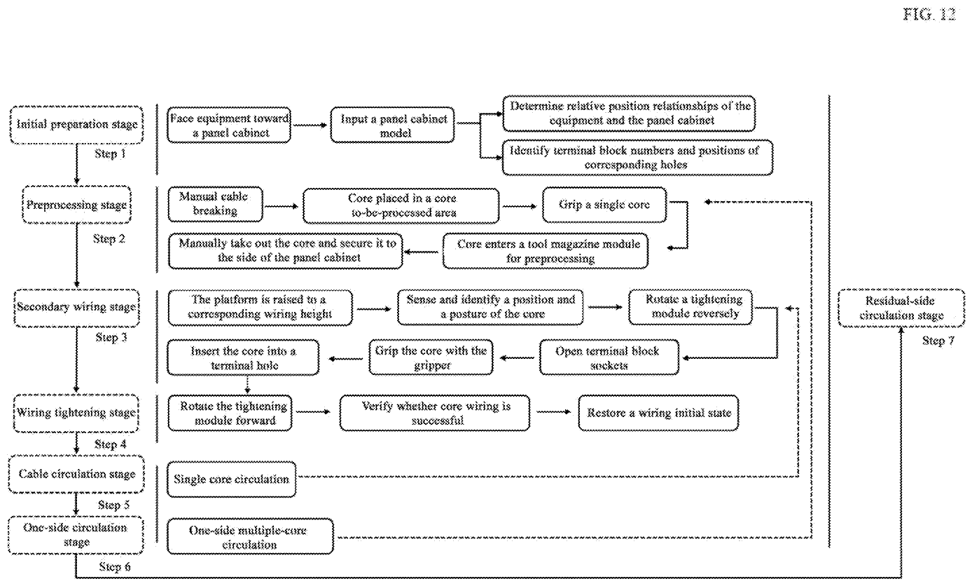

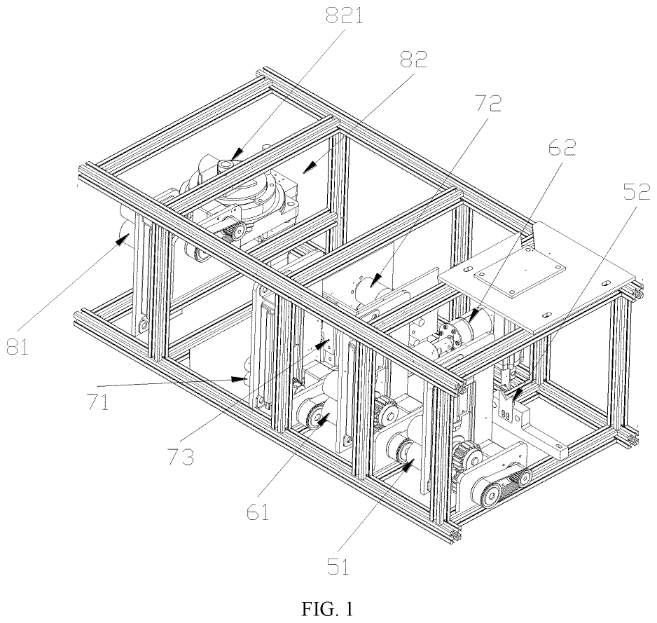

As shown in FIG. 1, a core preprocessing tool magazine of this embodiment includes a core cutting unit 50, a peeling processing unit 60, a cable marker sleeve unit 70, and a bending unit 80.

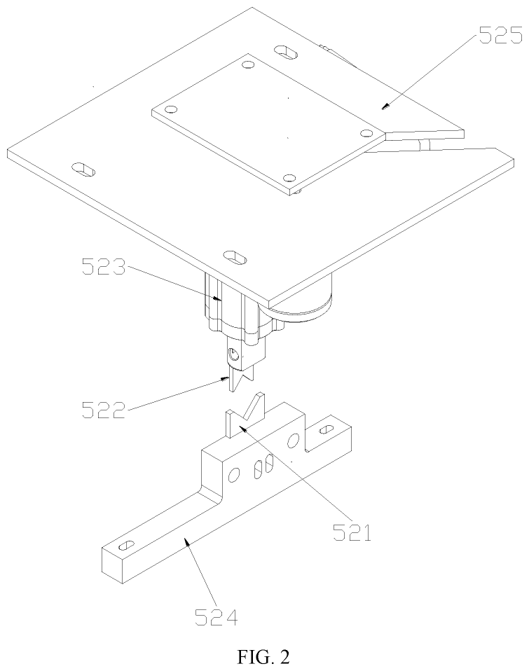

In this embodiment, the core cutting unit 50 includes a first core conveying mechanism 51 and a core cutting mechanism 52. The first core conveying mechanism 51 is used to drive a core to be cut to move toward the core cutting mechanism 52 and to drive the cut core to exit. As shown in FIG. 2, in this embodiment, the core cutting mechanism 52 includes a lower blade 521 and an upper blade 522 disposed opposite to each other, and a first power device 523 used to drive the lower blade 521 and the upper blade 522 to move relative to each other to cut off the core. In this embodiment, the core cutting mechanism 52 includes a lower mounting base 524 and an upper mounting base 525. The lower blade 521 is fixedly mounted on the lower mounting base 524, and the first power device 523 is fixedly mounted on the upper mounting base 525. The upper blade 522 is mounted on an output shaft of the first power device 523. The output shaft of the first power device 523 is located in the vertical direction and moves in a telescopic motion along the vertical direction to drive the lower blade 521 and the upper blade 522 to move relative to each other. Specifically, in this embodiment, the first power device 523 is an electric cylinder. Of course, in some other embodiments, the first power device 523 may also be a pneumatic cylinder, a hydraulic cylinder, or other linear drive mechanisms, which will not be described in detail here. Specifically, the height of the first core conveying mechanism 51 corresponds to that of the core cutting mechanism 52, so that the core conveyed by the first core conveying mechanism 51 can smoothly enter between the lower blade 521 and the upper blade 522 for a core cutting operation.

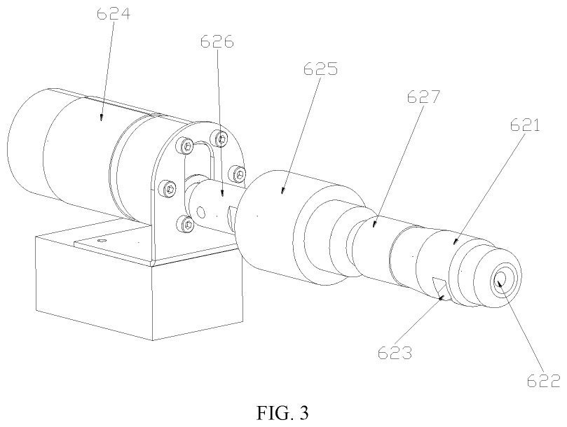

In this embodiment, the peeling processing unit 60 includes a second core conveying mechanism 61 and a peeling mechanism 62. The second core conveying mechanism 61 is used to drive the core to be peeled to move toward the peeling mechanism 62 and to drive the peeled core to exit. As shown in FIG. 3, in this embodiment, the peeling mechanism 62 includes a peeling cutter 621 and a second power device 624 used to drive the peeling cutter 621 to rotate about an axis thereof. In this embodiment, the peeling cutter 621 is provided with a through hole 622 for inserting the core inside. A side wall of the through hole 622 is provided with a cutter head mounting hole 623. A peeling cutter (not shown in the figure) for peeling the core is mounted in the cutter head mounting hole 623. In this way, after the second core conveying mechanism 61 drives the front end of the core to extend into the through hole 622, the peeling cutter 621 is driven to rotate by the second power device 624, so that a peeling operation of the core can be realized. In this embodiment, the second power device 624 is an electric motor. A chuck 625 is provided between the second power device 624 and the peeling cutter 621. One end of the chuck 625 is connected to an output shaft of the second power device 624 through a motor connecting rod 626, and the other end of the chuck 625 is connected to the peeling cutter 621 through a cutter connecting rod 627.

In this embodiment, the cable marker sleeving unit 70 includes a third core conveying mechanism 71, a cable marker conveying mechanism 72, and a cable marker cutting mechanism 73. Specifically, the third core conveying mechanism 71 and the cable marker conveying mechanism 72 are disposed opposite to each other and at a same height. The cable marker cutting mechanism 73 is located between the third core conveying mechanism 71 and the cable marker conveying mechanism 72 and is provided with a positioning support 731 used to position the core and a cable marker. The third core conveying mechanism 71 is used to drive the core to be sleeved to move toward the cable marker cutting mechanism 73 and to drive the sleeved core to exit. The cable marker conveying mechanism 72 is used to drive the cable marker to move toward the cable marker cutting mechanism 73 so as to sleeve the cable marker onto the corresponding core. The cable marker cutting mechanism 73 is used to cut off the cable marker so as to make an end of the cable marker remain on the core.

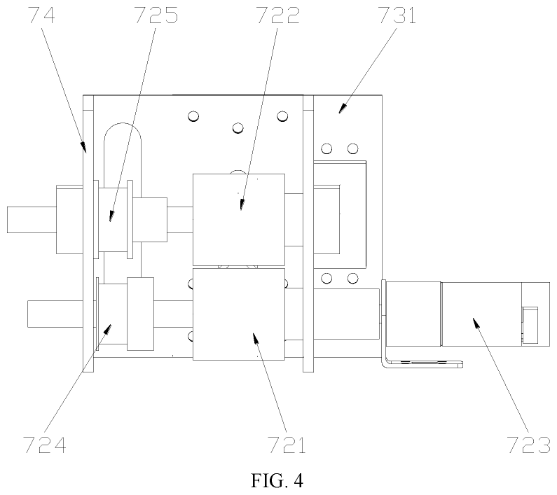

In this embodiment, the cable marker sleeving unit 70 includes a sleeve mounting frame 74, and the cable marker conveying mechanism 72 includes two sleeve conveying rollers disposed opposite to each other, namely a sleeve conveying roller 721 and a sleeve conveying roller 722, as shown in FIG. 4. Both the sleeve conveying roller 721 and the sleeve conveying roller 722 are rotatably fit and mounted on the sleeve mounting frame 74. The sleeve mounting frame 74 is provided with a sleeve conveying power device 723 that is connected to a rotating shaft of one of the sleeve conveying rollers 721. The sleeve conveying roller 721 and the sleeve conveying roller 722 are in transmission connection by a synchronous belt mechanism. Specifically, the sleeve conveying roller 721 and the sleeve conveying roller 722 are respectively provided with a drive pulley 724 and a driven pulley 725. A synchronous belt (not shown in the figure) is sleeved between the drive pulley 724 and the driven pulley 725. In this way, the sleeve conveying power device 723 drives the sleeve conveying roller 721 to rotate. Under the transmission action of the synchronous belt mechanism, the sleeve conveying roller 721 and the sleeve conveying roller 722 can rotate at a same speed and in opposite directions, so as to achieve the technical purpose of conveying the cable marker. In this embodiment, the sleeve conveying power device 723 is a DC motor.

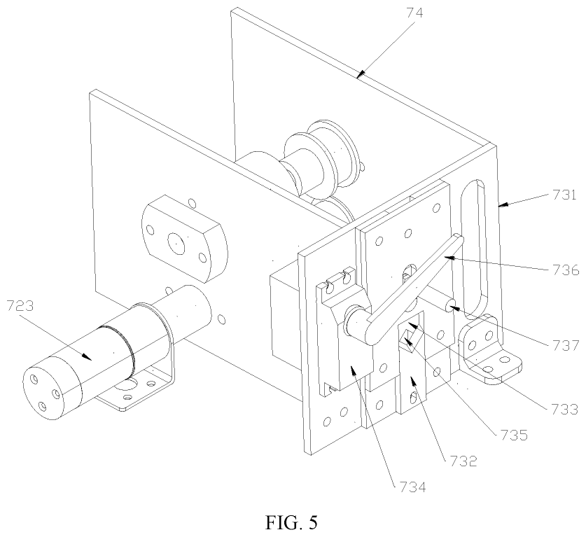

As shown in FIG. 5, in this embodiment, the cable marker cutting mechanism 73 includes a positioning support 731, a first blade 732 and a second blade 733 are disposed opposite to each other on the positioning support 731, and the second blade 733 is located below the first blade 732. In this embodiment, the second blade 733 is fixedly mounted on the positioning support 731. The positioning support 731 is provided with a vertical track inside. The first blade 732 is slidably fit and mounted in the vertical track. The positioning support 731 is provided with a reset spring (not shown in the figure) used to drive the first blade 732 to move upward and a third power device 734 used to drive the first blade 732 to move downward to cut off the cable marker. Specifically, the third power device 734 drives the first blade 732 to move downward to cut off the cable marker. After the cable marker cutting operation is completed, the third power device 734 no longer applies action force to the first blade 732, and the first blade 732 moves upward and resets under the action of the reset spring. Specifically, when the first blade 732 is reset under the action of the reset spring, a positioning through hole 735 used to position the core and the cable marker is formed between the first blade 732 and the second blade 733. The height for the third core conveying mechanism 71 and the cable marker conveying mechanism 72 to convey the core and the cable marker should be the same as the positioning through hole 735, so that the cable marker can pass through the positioning through hole 735 and be sleeved onto the end of the core. In this embodiment, the third power device 734 adopts a servo mounted on the positioning support 731. A rotating shaft of the servo is provided with a servo joystick 736. The first blade 732 is provided with a force-bearing rod 737 that cooperates with the servo joystick 736. The force-bearing rod 737 is parallel to the rotating shaft of the servo and perpendicular to the vertical track. When the cable marker cutting operation is executed, the rotating shaft of the servo rotates forward, causing the servo joystick 736 to apply downward force to the force-bearing rod 737. After being subjected to the downward force, the force-bearing rod 737 overcomes elastic force of the reset spring and moves downward with the first blade 732 under the guidance of the vertical track, cutting off the cable marker. After the cable marker cutting operation is completed, the rotating shaft of the servo rotates reversely, causing the servo joystick 736 to disengage from the force-bearing rod 737, and the first blade 732 moves upward to reset under the action of the reset spring.

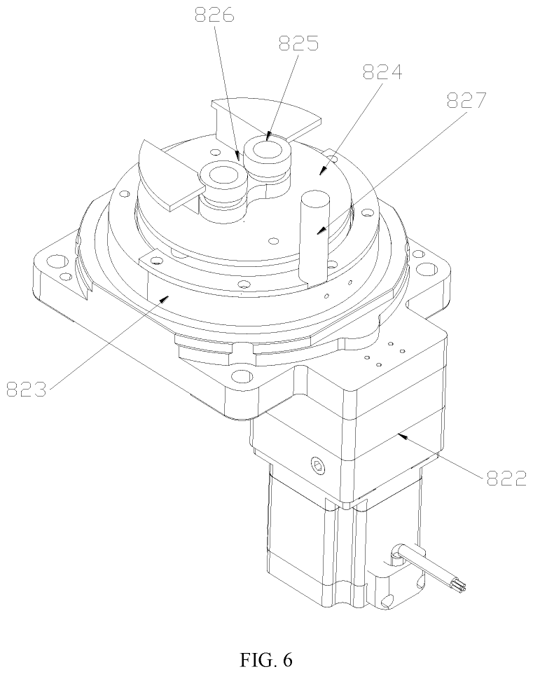

In this embodiment, the bending unit 80 includes a fourth core conveying mechanism 81 and a bending mechanism 82. The fourth core conveying mechanism 81 is used to convey the core to the bending mechanism in twice at a set length. As shown in FIG. 6, the bending mechanism 82 includes a bending turntable 821 and a fourth power device 822. The bending turntable 821 is used to bend the core in both forward and reverse directions. The fourth power device 822 is used to drive the bending turntable 821 to rotate in opposite directions after the core is conveyed to the bending turntable 821 in twice. Specifically, the bending turntable 821 in this embodiment includes a base turntable 823, a core guide plate 824 which is in rotating fit with the base turntable and is fixed is mounted on the base turntable 823. Two guide pillars 825 disposed opposite to each other are mounted on the core guide plate 824. A guide channel 826 for the core to pass through is formed between the two guide pillars 825. A bending pillar 827 used to drive bending of the core is mounted on the base turntable 823. The fourth power device 822 is in transmission connection with the base turntable 823. Specifically, when the fourth core conveying mechanism 81 conveys the core through the guide channel 826 and reaches the bending pillar 827, the fourth power device 822 drives the base turntable 823 to rotate, causing the bending pillar 827 to rotate relative to the guide pillar 825, and the bending pillar 827 drives the core to bend around the guide pillar 825.

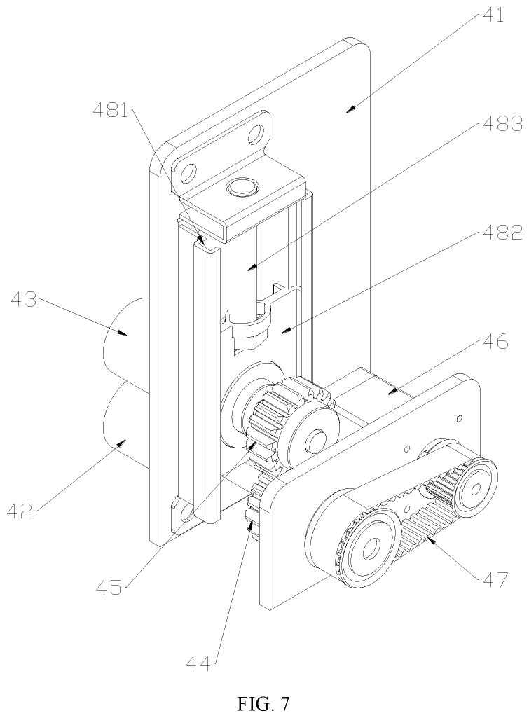

Specifically, in this embodiment, the first core conveying mechanism 51, the second core conveying mechanism 61, the third core conveying mechanism 71 and the fourth core conveying mechanism 81 adopt core conveying mechanisms of a same structure. As shown in FIG. 7, the core conveying mechanism of this embodiment includes a core conveying mounting frame 41. A first core conveying roller 42 and a second core conveying roller 43 disposed opposite to each other and a core conveying power device in transmission connection with a rotating shaft of the first core conveying roller 42 are mounted on the core conveying mounting frame 41. The rotating shafts of the first core conveying roller 42 and the second core conveying roller 43 are respectively provided with mutually meshing gears 44 and 45. A transmission ratio of gears 44 and 45 is 1. In this way, the first core conveying roller 42 and the second core conveying roller 43 can rotate synchronously with the same speed in opposite directions, so as to achieve the technical purpose of driving the core to move. The core conveying power device in this embodiment includes a power motor 46 mounted on the core conveying mounting frame 41. The output shaft of the power motor 46 is in transmission connection with the rotating shaft of the first core conveying roller 42 by a synchronous belt mechanism 47. In this embodiment, an encoder for calculating the length of the core is mounted on the power motor 46.

The core conveying mechanism in this embodiment further comprises a spacing adjustment mechanism used to adjust a position of the second core conveying roller 43. The spacing adjustment mechanism includes an adjustment track 481 disposed on the core conveying mounting frame 41 and a gap adjustment slider 482 in sliding fit with the adjustment track 481. The rotating shaft of the second core conveying roller 43 is in rotating fit with the gap adjustment slider 482. A position adjustment mechanism is disposed between the gap adjustment slider 482 and the core conveying mounting frame 41. The position adjustment mechanism is used to adjust the position of the gap adjustment slider 482 on the adjustment track 481 so as to adjust a spacing between the second core conveying roller 43 and the first core conveying roller 42. In this embodiment, the position adjustment mechanism uses a screw 483 used to adjust the position of the gap adjustment slider 482 on the adjustment track 481.

### Embodiment 2

This embodiment further proposes a core preprocessing method using the above core preprocessing tool magazine, including the following steps.
S1: core cutting
S11: gripping, by a robotic arm, the core and feeding the core into the first core conveying mechanism 51, after a photoelectric sensor detects that the core has been fed in place, starting the first core conveying mechanism 51 to convey the core toward the core cutting mechanism 52, and after a feeding length of the core is measured in real time to reach a first preset length value, stopping the first core conveying mechanism 51;
S12: starting the first power device 523 to drive the core cutting mechanism 52 to cut off the core, and after a grayscale sensor detects that the core has been cut off, using the first power device 523 to drive the core cutting mechanism 52 to reset;
S13: starting the first core conveying mechanism 51 to drive the cut core to exit from the core cutting unit 50, and after the photoelectric sensor detects that the core has completely exited, executing step S2;
S2: core peeling
S21: griping, by the robotic arm, the core and feeding the core into the second core conveying mechanism 61, after the photoelectric sensor detects that the core has been fed in place, starting the second core conveying mechanism 61 to convey the core toward the peeling mechanism 62, and after the feeding length of the core is measured in real time to reach a second preset length value, inserting an core end into the peeling cutter 621, and stopping the second core conveying mechanism 61;
S22: starting the second power device 624 to drive the peeling cutter 621 to rotate around an axis thereof to peel the core end, and after the grayscale sensor detects that the core end has been peeled, stopping the second power device 624;
S23: starting the second core conveying mechanism 61 to drive the peeled core to exit from the peeling processing unit, and after the photoelectric sensor detects that the core has completely exited, executing step S3;
S3: cable marker sleeving of the core
S31: griping, by the robotic arm, the core and feeding the core into the third core conveying mechanism 71, after the photoelectric sensor detects that the core has been fed in place, starting the third core conveying mechanism 71 to convey the core toward the cable marker cutting mechanism 73, and after the feeding length of the core is measured in real time to reach a third preset length value, stopping the third core conveying mechanism 71;
starting the cable marker conveying mechanism 72 to convey the cable marker toward the cable marker cutting mechanism 73, and after the cable marker is made to pass through the cable marker cutting mechanism 73 and reach a set position, sleeving a front end of the cable marker onto the core, and stopping the cable marker conveying mechanism;
S32: starting the cable marker cutting mechanism 73 to cut off the cable marker, and after the grayscale sensor detects that the core is sleeved with the cable marker, resetting the cable marker cutting mechanism;
S33: starting the third core conveying mechanism 71 to drive the sleeved core to exit from the cable marker sleeving unit 70, and after the photoelectric sensor detects that the core has completely exited, executing step S4;
S4: core bending
S41: gripping, by the robotic arm, the core and feeding the core into the fourth core conveying mechanism 81, after the photoelectric sensor detects that the core has been fed in place, starting the fourth core conveying mechanism 81 to convey the core toward the bending mechanism 82, and after the feeding length of the core is measured in real time to reach a fourth preset length value, stopping the fourth core conveying mechanism 81;
S42: starting the fourth power device 822 to drive the bending turntable 82 to rotate forward to the set position, and bending the core forward;
S43: starting the fourth core conveying mechanism 81 to convey the core toward the bending mechanism, and after the feeding length of the core is measured in real time to reach a fifth preset length value, stopping the fourth core conveying mechanism 81;
S44: starting the fourth power device 822 to drive the bending turntable 82 to rotate reversely to the set position, and bending the core reversely;
S45: gripping, by the robotic arm, the bent core, and using vision to detect an S-bend shape of the core.

In this embodiment, an encoder mounted on the power motor 46 is used to measure the conveying length of the core in real time.

### Embodiment 3

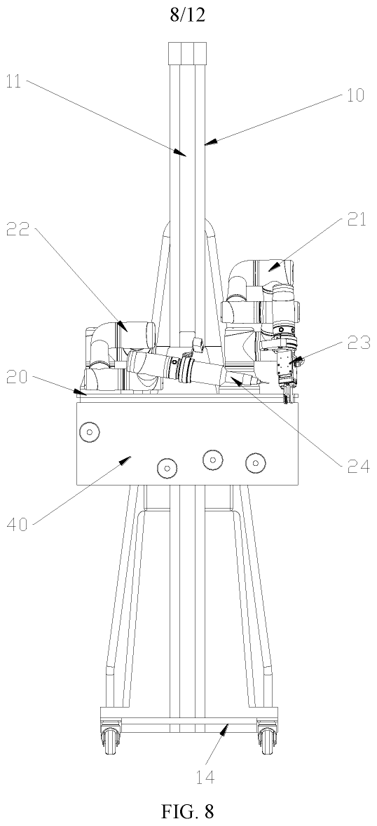

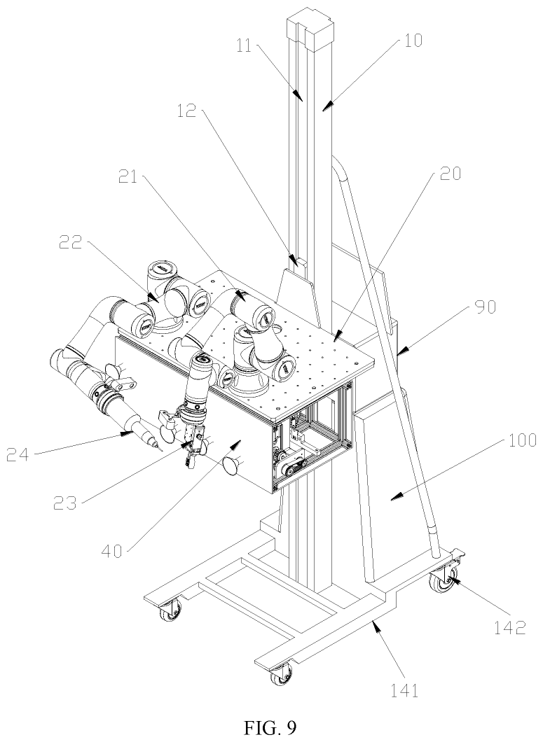

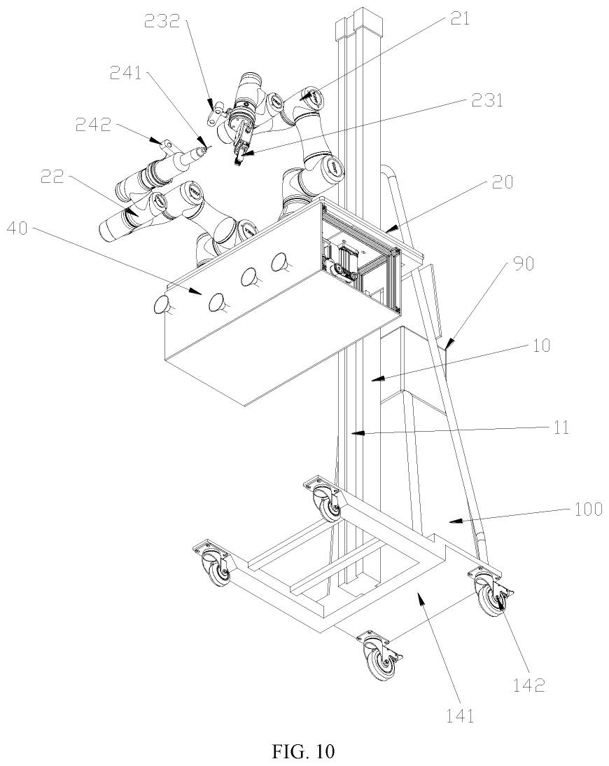

As shown in FIGS. 8-11, this embodiment further proposes mechanized intelligent equipment for substation secondary wiring, including a rack 10, a wiring work platform 20, a lifting module 30, a tool magazine module 40, a host computer module 90, and a slave computer module 100.

In this embodiment, the rack 10 is provided with a lifting mechanism. Specifically, the lifting mechanism in this embodiment includes a lifting track 11 mounted on the rack 10, a lifting slider 12 in sliding fit with the lifting track 11, and a motor transmission module 13 used to drive the lifting slider 12 to move along the lifting track. In a preferred implementation of the present disclosure, a movable platform 14 is disposed at the bottom of the rack 10. The movable platform 14 includes a base plate 141 and rollers 142 mounted on the base plate 142 to meet secondary wiring requirements of different panel cabinets.

In this embodiment, the wiring work platform 20 is mounted on the lifting mechanism and used to perform secondary wiring operations. Specifically, in this embodiment, the wiring work platform 20 is mounted on the lifting slider 12.

In this embodiment, the lifting module 30 is used to control the lifting mechanism to drive the wiring work platform 20 to perform lifting movements to meet wiring operation requirements of terminal blocks of different heights in a single panel cabinet. The lifting module 30 in this embodiment includes an ultrasonic ranging module 31 used to detect a distance of the lifting slider 12. The ultrasonic ranging module 31 can measure the height of the wiring work platform 20 by sensing the distance of the lifting slider 12, and use the lifting mechanism to drive the wiring work platform 20 to different wiring heights to complete the secondary wiring construction operations.

In this embodiment, the tool magazine module 40 is mounted on the wiring work platform 20 and is used to perform core preprocessing operations before secondary wiring.

In this embodiment, the host computer module 90 is used to deploy control programs required for secondary wiring operations. The host computer system performs high-level control over three slave computer modules 100, including processing secondary wiring task planning, deploying visual algorithms for perception and identification, and storing captured core attributes, core socket relationships, terminal block position information corresponding to cores with different attributes, etc.

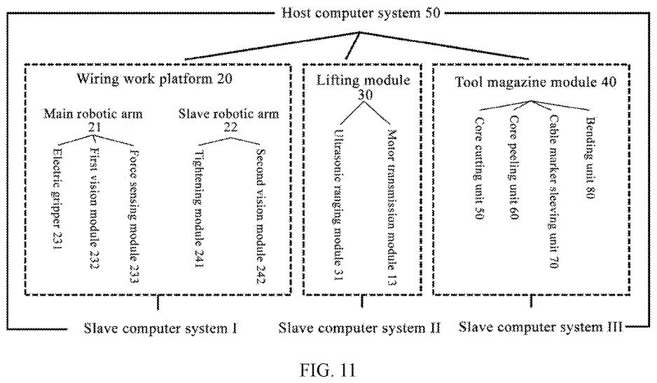

As shown in FIG. 11, in this embodiment, the slave computer module 100 is disposed in one-to-one correspondence with the wiring work platform 20, the lifting module 30 and the tool magazine block 40, and is used to control the corresponding wiring work platform 20, the lifting module 30 or the tool magazine module 40 to perform corresponding actions according to the control programs. The slave computer module 100 mainly includes driving of the motor and sensing and detection of related data. The main robotic arm 21, the slave robotic arm 22, and the main wiring execution module 23 and the slave wiring execution module 24 mounted at the end all use a dedicated control box for robotic arms as the slave computer control.

Specifically, there are three slave computer modules, which are respectively set to correspond to the wiring work platform 20, the lifting module 30 and the tool magazine module 40. In this embodiment, the slave computer module II, which is set corresponding to the lifting module 30, is used to control the lifting of the wiring work platform 20 through the motor transmission module 13 to adjust the height position, and is used to measure the distance of the lifting slider 12 through the ultrasonic ranging module 31 to obtain the height position of the wiring work platform 20.

The tool magazine module 40 in this embodiment includes a core cutting unit 50, a peeling processing unit 60, a cable marker sleeving unit 70, and a bending unit 80. Specifically, the core cutting unit 50 is used to perform a cutting operation on the core to adjust the core length. The peeling processing unit 60 is used to perform the peeling operation on the core and control the length of a copper wire exposed at the end of the core. The cable marker sleeving unit 70 is used to perform a cable marker sleeving operation on the core. The bending unit 80 is used to perform a bending operation on the front end of the core to bend the front end of the core into a set shape. Specifically, the tool magazine module 40 adopts the core preprocessing tool magazine described in Embodiment 1. Specifically, the slave computer module III, which is disposed in correspondence with the tool magazine module 40, is used to control the core cutting unit 50 to perform a cutting operation on the core to adjust the core length, control the peeling processing unit 60 to perform a peeling operation on the core and control the length of the copper wire exposed at the end of the core, control the cable marker sleeve unit 70 to perform a cable marker sleeving operation on the core, and control the bending unit 80 to perform a bending operation on the front end of the core to bend the front end of the core into a set shape.

In this embodiment, the wiring work platform 20 is provided with two robotic arms. The ends of the two robotic arms are interchangeably provided with a main wiring execution module 23 and a slave wiring execution module 24, wherein: The robotic arm provided with the main wiring execution module 23 is a main robotic arm 21, and the robotic arm provided with the slave wiring execution module 24 is a slave robotic arm 22. The main wiring execution module 23 and the slave wiring execution module 24 can be interchangeably mounted between the ends of the two robotic arms to meet the secondary wiring operation requirements on different sides of the panel cabinet.

In this embodiment, the main wiring execution module 23 includes an electric gripper 231, a first vision module 232, and a force sensing module 233. The electric gripper 231 is used to grip the core, the first vision module 232 is used to identify a position and a posture of the core, and the force sensing module 233 is used to sense whether core wiring is in place and secure. The slave wiring execution module 24 in this embodiment includes a tightening module 241 and a second vision module 242. The tightening module 241 is used to tighten screws on the side of the terminal block, and the second vision module 242 is used to identify the position of a terminal block socket. Specifically, the slave computer module I disposed in correspondence with the wiring work platform 20 is used to control the electric gripper 231 to perform the action of gripping the core, control the first vision module 232 and the second vision module 242 to collect image data, control the force sensing module 233 to collect the force bearing data of the core, and control the tightening module 231 to perform the action of tightening the side screws.

The mechanized intelligent equipment for substation secondary wiring in this embodiment uses the lifting mechanism on the rack in combination with the lifting module to control the height of the wiring work platform to meet the secondary wiring requirements at different height positions in the panel cabinet. By mounting the tool magazine module on the wiring work platform, the cutting, peeling, cable marker sleeving and bending operations can be conducted on the core through the core cutting unit, the peeling processing unit, the cable marker sleeving unit and the bending unit respectively, so as to meet the preprocessing work before secondary wiring of the core. By mounting the two robotic arms on the wiring work platform, and mounting the main wiring execution module and the slave wiring execution module at the ends of the two robotic arms, the electric gripper, first vision module and force sensing module in the main robotic arm and the main wiring execution module can be used to realize gripping of the core, insertion of the core into the terminal block socket and detection of whether the core is inserted in place and secure. The technical objective of tightening the side screws of the terminal block can be achieved by using the tightening module and the second vision module in the robotic arm and the slave wiring execution module. All of the above secondary wiring operations can be achieved through the control programs deployed in the upper computer module in combination with the slave computer module for action control. Specifically, the mechanized intelligent equipment for substation secondary wiring of the present disclosure solves the problem of insufficient efficiency of the prior art, greatly reduces the participation of manpower, and improves the level of intelligence of construction.

### Embodiment 4

It should be noted that, according to the State Grid secondary wiring process standards, secondary wiring requires splitting laid cables into multiple strands of cores, processing ends of cores according to wiring drawings, connecting them to corresponding terminal blocks, and tightening side screws in the terminal blocks. The effectiveness of the secondary wiring is ensured through the crimping of the cores. Due to limitations of mechanized construction equipment, the original manual wiring methods and processes are not entirely applicable to mechanized construction. Therefore, this embodiment redesigns construction processes of the mechanized construction equipment for substation secondary wiring based on the aforementioned mechanized intelligent equipment for substation secondary wiring, and proposes a mechanized intelligent construction method for substation secondary wiring.

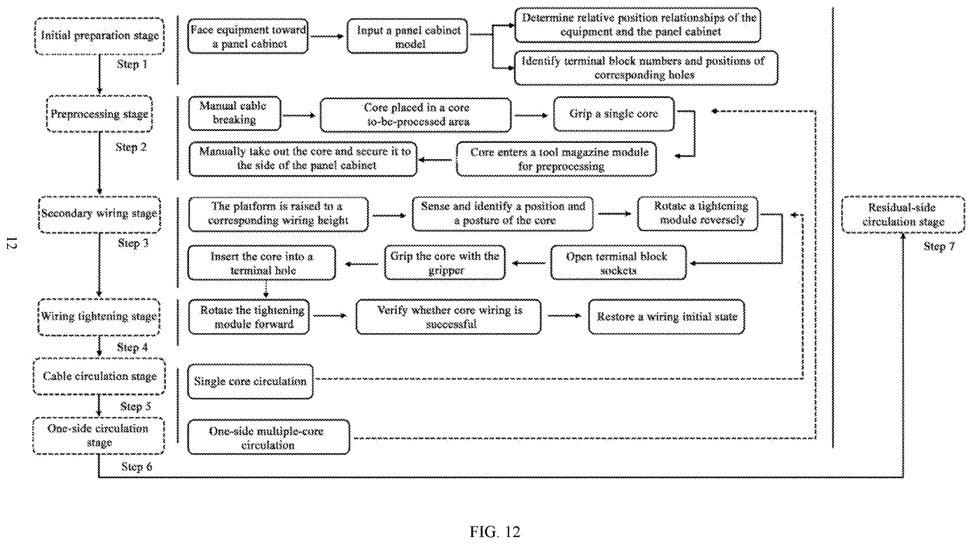

As shown in FIG. 12, a mechanized intelligent construction method for substation secondary wiring in this embodiment includes the following steps:

Step 1: Initial Preparation stage

A rack position is adjusted, so that a wiring work platform 20 faces a panel cabinet directly; wiring information of the corresponding panel cabinet and actual terminal block position information are acquired.

Specifically, the initial preparation stage includes the following steps:
11) Adjusting a rack position, so that a wiring work platform 20 faces a panel cabinet directly; initializing a host computer module 90 and a slave computer module 100 to put a wiring work platform 20, a lifting module 30 and a tool magazine module 40 into initial states.
12) Inputting a panel cabinet model and a cable number for secondary wiring into the host computer module 90 to obtain wiring information of the panel cabinet.
13) Using a main robotic arm 21 to drive a first vision module 232 to move to determine relative position relationships of the wiring work platform 20 and the panel cabinet, and to identify a terminal block number and actual position information of a corresponding socket.

### Step 2: Preprocessing Stage

An operation cable is selected and split into multiple strands of cores; the main robotic arm 21 is used to drive an electric gripper 231 to grip the cores and transfer them to a tool magazine module 40; the tool magazine module 40 then performs preprocessing on the cores, including a cutting operation, a peeling operation, a cable marker sleeving operation, and a bending operation.

Specifically, the preprocessing stage includes the following steps:
21) After selecting an operation cable, splitting the cable into multiple strands of cores and placing the multiple strands of cores in a core to-be-processed area.
22) Using the main robotic arm 21 to drive the first vision module 232 to identify a position and a posture of the core in the core to-be-processed area, and using the main robotic arm 21 to drive an electric gripper 231 to grip one of the single cores.
23) Using the main robotic arm 21 to drive the electric gripper 231 to transfer the gripped core to a core cutting unit 50 of the tool magazine module 40, using the core cutting unit 50 to perform a cutting operation on the core to adjust the core length to a length suitable for the height of the terminal block.
24) Using the main robotic arm 21 to drive the electric gripper 231 to transfer the cut core to a peeling processing unit 60, and using the peeling processing unit 60 to perform a peeling operation on the core and control the length of a copper wire exposed at the end of the core.
26) Using the main robotic arm 21 to drive the electric gripper 231 to transfer the peeled core to a cable marker sleeving unit 70, and using the cable marker sleeving unit 70 to perform a cable marker sleeving operation on the core so as to sleeve a numbered cable marker on the core.
27) Using the main robotic arm 21 to drive the electric gripper 231 to transfer the gripped sleeved core to the a bending unit 80, where the bending unit 80 can be used to perform a bending operation on the front end of the core to bend the front end of the core into a set shape. In this embodiment, the front end of the core is bent into an “S” shape.
28) Manually taking out the bent core from the tool magazine module 40 and binding the core to the side of the current wiring of the panel cabinet, so that the part of the core bent into an “S” shape is located close to the wiring.
29) Using the core gripped by the electric gripper 231 driven by the main robotic arm 21 to repeat execution of steps 23)-28) until all cores of the same cable have been preprocessed.

### Step 3: Secondary Wiring Stage

A lifting module 30 is used to control a lifting mechanism to adjust the position height of the wiring work platform 20 to the secondary wiring height, the main robotic arm 21 is used to drive the electric gripper 231 to grip one of the cores and insert the end of the core into the corresponding socket of the terminal block.

Specifically, the steps of the secondary wiring stage are as follows:
31) Using a lifting module 30 to control a lifting mechanism to drive the wiring work platform 20 to move to the wiring height of the corresponding core.
32) Using the main robotic arm 21 to drive a first vision module 232 to identify a position and a posture of the current core.
33) Using a slave robotic arm 22 to drive a slave wiring execution module 24 to move to the terminal block position corresponding to the current core, and with the cooperation of a second vision module 242, making a tightening module 241 aligned with a side screw of the terminal block.
34) Using the slave robotic arm 22 to drive the tightening module 241 to drive the corresponding side screw to reverse so as to make a pressure block in the corresponding terminal block socket return to an initial state, and opening the terminal block socket.
35) Using the main robotic arm 21 to drive the electric gripper 231 to grip the core and move it toward the corresponding terminal block socket, and with the cooperation of the first vision module 232, making the front end of the core aligned with the terminal block socket.
36) Using the main robotic arm 21 to drive the electric gripper 231 to drive the core to move toward the corresponding terminal block socket, and using a force sensing module 233 to detect force on the core so as to sense the change in a contact surface between the core and the socket until the front end of the core contacts the bottom of the socket.

### Step 4: Wiring Tightening Stage

The core is fixed in the corresponding terminal block socket by tightening the corresponding side screws using the tightening module 241 driven by the slave robotic arm 22.

Specifically, the steps of the wiring tightening stage are as follows:
41) Using the slave robotic arm 22 to drive the tightening module 241 to drive the side screw to rotate forward, so that the pressure block in the terminal block socket presses and fixes the core in the corresponding terminal block socket.
42) Driving the slave robotic arm 22 to reset to the initial position and posture.
43) Using the main robotic arm 21 to drive the electric gripper 231 to drive the core to move in the direction away from the corresponding terminal block socket, using the force sensing module 233 to detect the force on the core to determine whether the core is secure: If so, executing step 44); if not, repeating step 3.
44) Use the main robotic arm 21 to drive the electric gripper 231 to release the core, and driving the main robotic arm 21 to reset to the initial position and posture.

### Step 5: Cable Circulation Stage

Step 3 and Step 4 are repeated until all cores belonging to the same cable have completed the secondary wiring operation;

### Step 6: One-Side Circulation Stage

Step 2 and Step 4 are repeated until all cables on one side of the panel cabinet have completed the secondary wiring operation.

### Step 7: Residual-Side Circulation Stage

The main wiring execution module 23 and the slave wiring execution module 24 are interchanged and mounted in the two robotic arms, and Steps 2 to 6 are repeated until all secondary wiring operations of the panel cabinet are completed.

The mechanized intelligent construction method for substation secondary wiring in this embodiment addresses the lack and non-standardization of the operation mode of mechanized construction equipment for substation secondary wiring. A relatively detailed operation method for mechanized construction equipment for secondary wiring is proposed, effectively solving the problem of complicated processes in construction and reducing the risk of construction accidents.

The above-described embodiments are merely preferred embodiments for the purpose of fully illustrating the present disclosure, and the scope of protection of the present disclosure is not limited thereto. All equivalent substitutions or modifications made by those skilled in the art based on the present disclosure are within the protection scope of the present disclosure. The scope of protection of the present disclosure is defined by the claims.

1. A wire core preprocessing tool magazine, comprising a wire cutting unit, a peeling processing unit, a cable marker sleeving unit, and a bending unit, wherein
the wire cutting unit comprises a first wire conveying mechanism and a wire cutting mechanism; the first wire conveying mechanism is used to drive a core to be cut to move toward the wire cutting mechanism and to drive the cut core to exit; the wire cutting mechanism comprises a lower blade and an upper blade disposed opposite to each other, and a first power device used to drive the lower blade and the upper blade to move relative to each other to cut off the core;
the peeling processing unit comprises a second wire conveying mechanism and a peeling mechanism; the second wire conveying mechanism is used to drive the core to be peeled to move toward the peeling mechanism and to drive the peeled core to exit; the peeling mechanism comprises a peeling cutter and a second power device used to drive the peeling cutter to rotate about an axis thereof;
the cable marker sleeving unit comprises a third wire conveying mechanism, a cable marker conveying mechanism, and a cable marker cutting mechanism; the third wire conveying mechanism and the cable marker conveying mechanism are disposed opposite to each other and at a same height; the cable marker cutting mechanism is located between the third wire conveying mechanism and the cable marker conveying mechanism and is provided with a positioning support used to position the core and a cable marker; the third wire conveying mechanism is used to drive the core to be sleeved to move toward the cable marker cutting mechanism and the sleeved core to exit; the cable marker conveying mechanism is used to drive the cable marker to move toward the cable marker cutting mechanism so as to sleeve the cable marker onto the corresponding core; and the cable marker cutting mechanism is used to cut off the cable marker so as to make an end of the cable marker remain on the core; and
the bending unit comprises a fourth wire conveying mechanism and a bending mechanism; the fourth wire conveying mechanism is used to convey the core to the bending mechanism in twice at a set length; the bending mechanism comprises a bending turntable and a fourth power device; the bending turntable is used to bend the core in both forward and reverse directions; and the fourth power device is used to drive the bending turntable to rotate in opposite directions respectively after the core is conveyed to the bending turntable in twice.

2. The wire core preprocessing tool magazine according to claim 1, wherein the first wire conveying mechanism, the second wire conveying mechanism, the third wire conveying mechanism, and the fourth wire conveying mechanism are wire conveying mechanisms adopting a same structure; the wire conveying mechanism comprises a core conveying mounting frame, a first core conveying roller and a second core conveying roller disposed opposite to each other and a core conveying power device in transmission connection with a rotating shaft of the first core conveying roller are mounted on the core conveying mounting frame; the rotating shafts of the first core conveying roller and the second core conveying roller are provided with mutually meshing gears respectively.

3. The wire core preprocessing tool magazine according to claim 2, wherein the core conveying power device comprises a power motor mounted on the core conveying mounting frame, and an output shaft of the power motor is in transmission connection with the rotating shaft of the first core conveying roller by a synchronous belt mechanism.

4. The wire core preprocessing tool magazine according to claim 3, wherein the wire conveying mechanism further comprises a spacing adjustment mechanism used to adjust a position of the second core conveying roller; the spacing adjustment mechanism comprises an adjustment track disposed on the core conveying mounting frame and a gap adjustment slider in sliding fit with the adjustment track, and the rotating shaft of the second core conveying roller is in rotating fit with the gap adjustment slider; a position adjustment mechanism is disposed between the gap adjustment slider and the core conveying mounting frame; the position adjustment mechanism is used to adjust a position of the gap adjustment slider on the adjustment track to adjust a spacing between the second core conveying roller and the first core conveying roller.

5. The wire core preprocessing tool magazine according to claim 1, wherein the peeling cutter is provided with a through hole for inserting the core inside, and a cutter head mounting hole is provided on a side wall of the through hole; and a peeling cutter head used to peel the core is mounted in the cutter head mounting hole.

6. The wire core preprocessing tool magazine according to claim 1, wherein the cable marker sleeving unit comprises a sleeve mounting frame, the cable marker conveying mechanism comprises two sleeve conveying rollers disposed opposite to each other; the two sleeve conveying rollers are rotatably fit and mounted on the sleeve mounting frame; the sleeve mounting frame is provided with a sleeve conveying power device in transmission connection with the rotating shaft of one of the sleeve conveying rollers, and the two sleeve conveying rollers are in transmission connection by a synchronous belt mechanism.

7. The wire core preprocessing tool magazine according to claim 1, wherein the cable marker cutting mechanism comprises a positioning support, a first blade and a second blade are disposed opposite to each other on the positioning support, and the second blade is located below the first blade; the second blade is fixedly mounted on the positioning support, a vertical track is disposed in the positioning support, the first blade is slidably fit and mounted in the vertical track, and the positioning support is provided with a reset spring used to drive the first blade to move upward and a third power device used to drive the first blade to move downward to cut off the cable marker; and when the first blade is reset by the action of the reset spring, a positioning through hole used to position the core and the cable marker is formed between the first blade and the second blade.

8. The wire core preprocessing tool magazine according to claim 1, wherein the bending turntable comprises a base turntable, a core guide plate which is in rotating fit with the base turntable and is fixed is mounted on the base turntable, two guide pillars disposed opposite to each other are mounted on the core guide plate, and a guide channel used for the core to pass through is formed between the two guide pillars; the base turntable is provided with a bending pillar used to drive bending of the core; and the fourth power device is in transmission connection with the base turntable.

9. A core preprocessing method using the wire core preprocessing tool magazine as described in claim 1, comprising the following steps:
S1: wire core cutting
S11: gripping, by a robotic arm, the core and feeding the core into the first wire conveying mechanism, after a photoelectric sensor detects that the core has been fed in place, starting the first wire conveying mechanism to convey the core toward the wire cutting mechanism, and after a feeding length of the core is measured in real time to reach a first preset length value, stopping the first wire conveying mechanism;
S12: starting the first power device to drive the wire cutting mechanism to cut off the core, and after a grayscale sensor detects that the core has been cut off, using the first power device to drive the wire cutting mechanism to reset;
S13: starting the first wire conveying mechanism to drive the cut core to exit from the wire cutting unit, and after the photoelectric sensor detects that the core has completely exited, executing step S2;
S2: wire core peeling
S21: griping, by the robotic arm, the core and feeding the core into the second wire conveying mechanism, after the photoelectric sensor detects that the core has been fed in place, starting the second wire conveying mechanism to convey the core toward the peeling mechanism, and after the feeding length of the core is measured in real time to reach a second preset length value, inserting an core end into the peeling cutter, and stopping the second wire conveying mechanism;
S22: starting the second power device to drive the peeling cutter to rotate around an axis thereof to peel the core end, and after the grayscale sensor detects that the core end has been peeled, stopping the second power device;
S23: starting the second wire conveying mechanism to drive the peeled core to exit from the peeling processing unit, and after the photoelectric sensor detects that the core has completely exited, executing step S3;
S3: cable marker sleeving of the core
S31: griping, by the robotic arm, the core and feeding the core into the third wire conveying mechanism, after the photoelectric sensor detects that the core has been fed in place, starting the third wire conveying mechanism to convey the core toward the cable marker cutting mechanism, and after the feeding length of the core is measured in real time to reach a third preset length value, stopping the third wire conveying mechanism;
starting the cable marker conveying mechanism to convey the cable marker toward the cable marker cutting mechanism, and after the cable marker is made to pass through the cable marker cutting mechanism and reach a set position, sleeving a front end of the cable marker onto the core, and stopping the cable marker conveying mechanism;
S32: starting the cable marker cutting mechanism to cut off the cable marker, and after the grayscale sensor detects that the core is sleeved with the cable marker, resetting the cable marker cutting mechanism;
S33: starting the third wire conveying mechanism to drive the sleeved core to exit from the cable marker sleeving unit, and after the photoelectric sensor detects that the core has completely exited, executing step S4;
S4: core bending
S41: gripping, by the robotic arm, the core and feeding the core into the fourth wire conveying mechanism, after the photoelectric sensor detects that the core has been fed in place, starting the fourth wire conveying mechanism to convey the core toward the bending mechanism, and after the feeding length of the core is measured in real time to reach a fourth preset length value, stopping the fourth wire conveying mechanism;
S42: starting the fourth power device to drive the bending turntable to rotate forward to the set position, and bending the core forward;
S43: starting the fourth wire conveying mechanism to convey the core toward the bending mechanism, and after the feeding length of the core is measured in real time to reach a fifth preset length value, stopping the fourth wire conveying mechanism;
S44: starting the fourth power device to drive the bending turntable to rotate reversely to the set position, and bending the core reversely;
S45: gripping, by the robotic arm, the bent core, and using vision to detect an S-bend shape of the core.

10. Mechanized intelligent equipment for substation secondary wiring, comprising:
a rack, provided with a lifting mechanism;
a wiring work platform, mounted on the lifting mechanism and used to perform secondary wiring operations;
a lifting module, used to control the lifting mechanism to drive the wiring work platform to perform lifting movements so as to meet wiring operation requirements of terminal blocks at different heights within a single panel cabinet;
a tool magazine module, mounted on the wiring work platform and used to perform core preprocessing operations before secondary wiring;
a host computer module, used to deploy control programs required for the secondary wiring operations;
a slave computer module, disposed in one-to-one correspondence with the wiring work platform, the lifting module and the tool magazine module, and used to control the corresponding wiring work platform, the lifting module or the tool magazine module to perform corresponding actions according to the control programs;
the tool magazine module adopts the wire core preprocessing tool magazine as described in claim 1;
the wiring work platform is provided with two robotic arms, and the ends of the two robotic arms are interchangeably provided with a main wiring execution module and a slave wiring execution module, wherein: the robotic arm provided with the main wiring execution module is a main robotic arm, and the robotic arm provided with the slave wiring execution module is a slave robotic arm;
the main wiring execution module comprises an electric gripper, a first vision module, and a force sensing module, wherein the electric gripper is used to grip the core, the first vision module is used to identify a position and a posture of the core, and the force sensing module is used to sense whether core wiring is in place and secure; the slave wiring execution module comprises a tightening module and a second vision module, wherein the tightening module is used to tighten screws on the side of the terminal block, and the second vision module is used to identify a position of a terminal block socket.
